(19) United States
(12) Patent Application Publication
(10) Pub. No.: US 2019/0280550 A1
(43) Pub. Date: Sep. 12, 2019

(54) LAMINATED STACK MOTOR

(71) Applicant: ThinGap LLC, Camarillo, CA (US)

(72) Inventors: Joseph Kay, Camarillo, CA (US); Evan E. Frank, Camarillo, CA (US); Donald A. Harris, Camarillo, CA (US); Charles Descoteaux, Camarillo, CA (US)

(21) Appl. No.: 15/914,643

(22) Filed: Mar. 7, 2018

(51) Int. Cl. H02K 3/48; H02K 1/18; H02K 1/16; H02K 1/17

(52) U.S. Cl. CPC H02K 3/48; H02K 1/18; H02K 2203/12; H02K 1/17; H02K 1/16

(57) ABSTRACT

An apparatus including a stator coil including a laminated stack including a wire-wrapped bobbin. The bobbin including a cylindrical bobbin having an inner bobbin surface and an outer bobbin surface, at least one wire wrapped around both the inner and outer surfaces of the cylindrical bobbin to form a winding, and a first layer of one or more fiber strands wound on the inner surface of the wire-wrapped cylindrical bobbin and a second layer of one or more fiber strands wound on the outer surface of the wire-wrapped cylindrical bobbin. The stator coil comprising a cured potting material potting the wire-wrapped cylindrical bobbin and bonding the wire-wrapped cylindrical bobbin together and further comprising a first layer of one or more fiber strands wound on the inner surface of the stator coil and the second layer of one or more fiber strands wound on the outer surface of the stator coil.

### BACKGROUND

### Field

The present disclosure relates to electromechanical power conversion. More particularly, the disclosure relates to brushless permanent magnet motors.

### Background

An electric motor is an electrical apparatus that converts electrical energy into mechanical energy. For example, some electrical motors may convert electrical energy into rotational mechanical energy. Other electrical motors may convert electrical energy into linear mechanical energy. Generally, an electric motor may function using windings that conduct current that may interact with a magnetic field to generate a rotational or linear force.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, an apparatus including a stator coil. The stator coil including a laminated stack including a wire-wrapped cylindrical bobbin. The wire-wrapped cylindrical bobbin including a cylindrical bobbin having an inner bobbin surface and an outer bobbin surface, at least one wire wrapped around both the inner and outer surfaces of the cylindrical bobbin to form a winding, and a first layer of one or more fiber strands wound on the inner surface of the wire-wrapped cylindrical bobbin and a second layer of one or more fiber strands wound on the outer surface of the wire-wrapped cylindrical bobbin. The stator coil including a cured potting material potting the wire-wrapped cylindrical bobbin and bonding the wire-wrapped cylindrical bobbin together and further including a first layer of one or more fiber strands wound on the inner surface of the stator coil and the second layer of one or more fiber strands wound on the outer surface of the stator coil and laminated stack. The apparatus including a rotor including a cylindrical ferrous ring having an inner and an outer surface, and a plurality of permanent magnets arranged on either the inner or outer surface of the cylindrical ferrous ring.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a conceptual representation of a stator and a rotor of the present disclosure.

FIG. 2 is a diagram illustrating a laminated stack motor cross-section.

FIG. 3A illustrates a cross-section of a Litz wire bundle.

FIG. 3B illustrates details of a cross-section of a Litz wire bundle.

FIG. 4 illustrates twisted filaments and insulation of a Litz wire bundle.

FIG. 5 illustrates a flat form of a stator bobbin.

FIG. 6 illustrates the bobbin of FIG. 6 curved to form a cylinder.

FIG. 7 is a diagram illustrating two Litz wire bundles wrapped around the edge of a bobbin.

FIG. 8 is a diagram illustrating a conceptual representation of a stator and a rotor of the present disclosure.

FIG. 9 is a flowchart of illustrating a method of assembling a stator in accordance with the disclosure.

FIG. 10 is a flowchart of illustrating a method of laminated stack motor manufacture.

### DETAILED DESCRIPTION

Various concepts will now be presented with reference to a stator and rotor for an electric motor or electric power generator.

It is to be understood that the specific order or hierarchy of steps in the methods and processes disclosed is an illustration of exemplary processes. Based upon design preferences, it is understood that the specific order or hierarchy of steps in the methods may be rearranged.

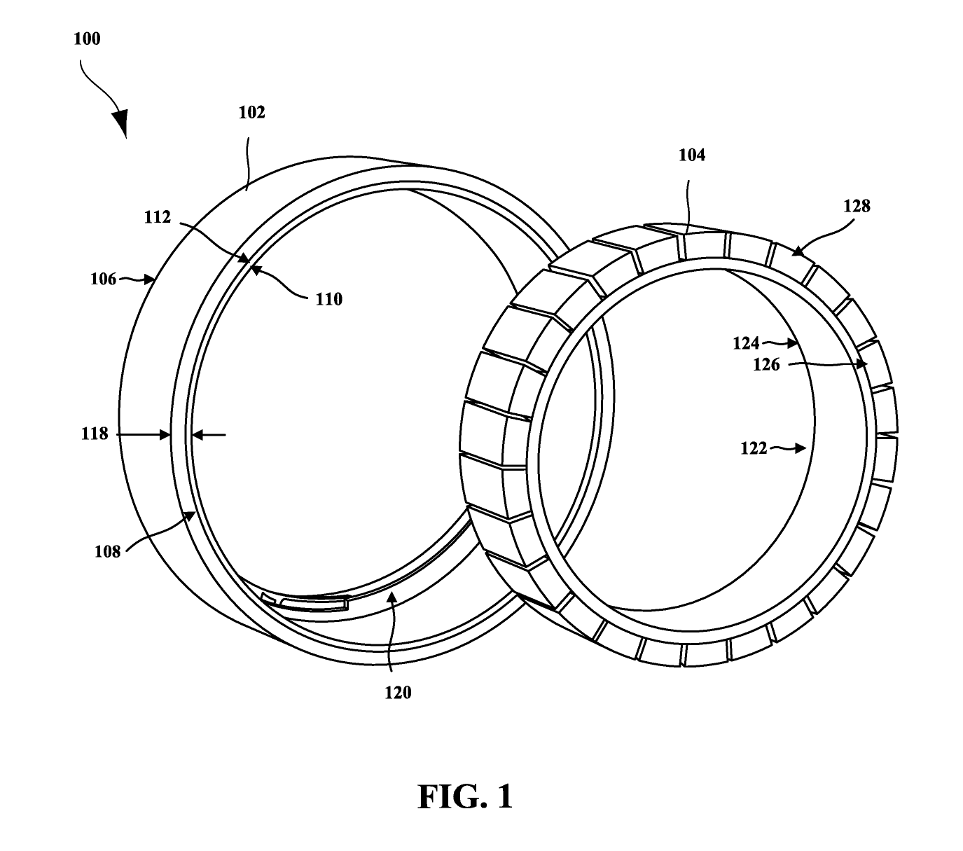

FIG. 1 is a diagram 100 illustrating a conceptual representation of a stator 102 and a rotor 104 of the present disclosure. The stator 102 is the stationary part of a rotary systems, e.g., such as the electric motor. The rotor 104 is a moving component of an electromagnetic system, e.g., such as the electric motor.

Eddie currents may cause losses to be (relatively) high in a solid stator, e.g., if the stator 102 includes solid ferrous material. In an aspect of the application, a stack of laminated ferrous material may be used to break up the induced current. By lowering the induced current, less heating may occur in the stator. Accordingly, in an aspect, the stator 102 may consist of multiple laminated layers.

In an aspect, the stator 102 may include a laminated stack 106. The laminated stack 106 may be on the inside or the outside of a wire-wrapped cylindrical bobbin 108. FIG. 1 illustrates an example with the laminated stack 106 outside of the wire-wrapped cylindrical bobbin 108. The wire-wrapped cylindrical bobbin 108 may include a cylindrical bobbin and at least one wire wrapped around both the inner and outer surfaces of the cylindrical bobbin. The wire-wrapped cylindrical bobbin 108 may have an inner bobbin surface 110 and an outer bobbin surface 112.

In an aspect, at least one wire may be wrapped around both the inner bobbin surface 110 and the outer bobbin surface 112 to form a winding. The wire-wrapped cylindrical bobbin further includes at least one fiber strand wrapped around the surface of the winding. A cured potting material may be used for potting the wire-wrapped cylindrical bobbin.

In an aspect, the laminated stack 106 may provide a low thermal resistance heat path 118.

In an aspect, the windings of the stator 102 may provide configurable windings that may accommodate a range of voltages.

In an aspect, the stator 102 may include an integrated rotor position sensor 120.

In an aspect, an assembly may be a cylindrical bobbin. The cylindrical bobbin may include a wire-wrapped cylindrical bobbin and the wire-wrapped cylindrical bobbin has an inner surface and an outer surface, and at least one wire wrapped around both the inner and outer surfaces of the cylindrical bobbin to form a wire-wrapped cylindrical bobbin having an inner surface and an outer surface. The wire-wrapped cylindrical bobbin may further include at least one fiber strand wrapped around the inner and outer surfaces of the wire-wrapped cylindrical bobbin. The assembly, e.g., the cylindrical bobbin including, e.g., including the inner surface and the outer surface, may further include a laminated stack on either of the inner or outer surface of the assembly.

In an aspect, a cylindrical bobbin may be porous and a potting material may infuse the cylindrical bobbin, the at least one wire, the one or more fiber strands, and the voids between the fiber strands and the stator ferrous ring.

In an aspect, the stator 102 has a rigidity reinforced by the one or more fiber strands and the laminated stack 106 is bonded to the cylindrical bobbin and the fiber strands.

In an aspect, the stator ferrous ring includes a stack of thin cylindrical rings.

In an aspect, the one or more fiber strands includes fiberglass.

In an aspect, the potting material includes at least one of epoxy and resin.

In an aspect, the rotor ferrous ring includes a solid cylindrical ring.

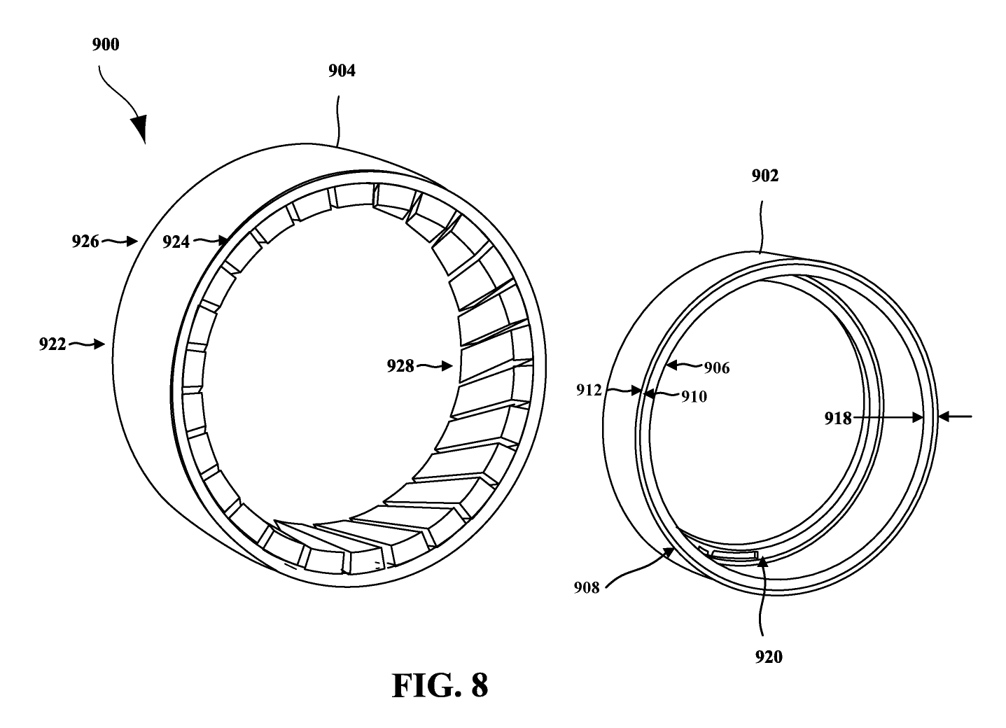

The rotor 104 includes a cylindrical ferrous ring 122. The cylindrical ferrous ring 122 may have an inner surface 124 and an outer surface 126. The cylindrical ferrous ring 122 may have a plurality of permanent magnets 128 arranged on either the inner surface 124 or the outer surface 126 of the cylindrical ferrous ring 122. The cylindrical ferrous ring 122 may have a plurality of permanent magnets 128 arranged on the outer surface 126 of the cylindrical ferrous ring 122 as illustrated in the example of FIG. 1. In an aspect, the cylindrical ferrous ring 122 and the one or more fiber strands may be on either the inner surface (FIG. 1) or outer surface (FIG. 8) of the cylindrical bobbin and the one or more fiber strands.

In an aspect, the stator 102 and rotor 104 may have a large clear aperture.

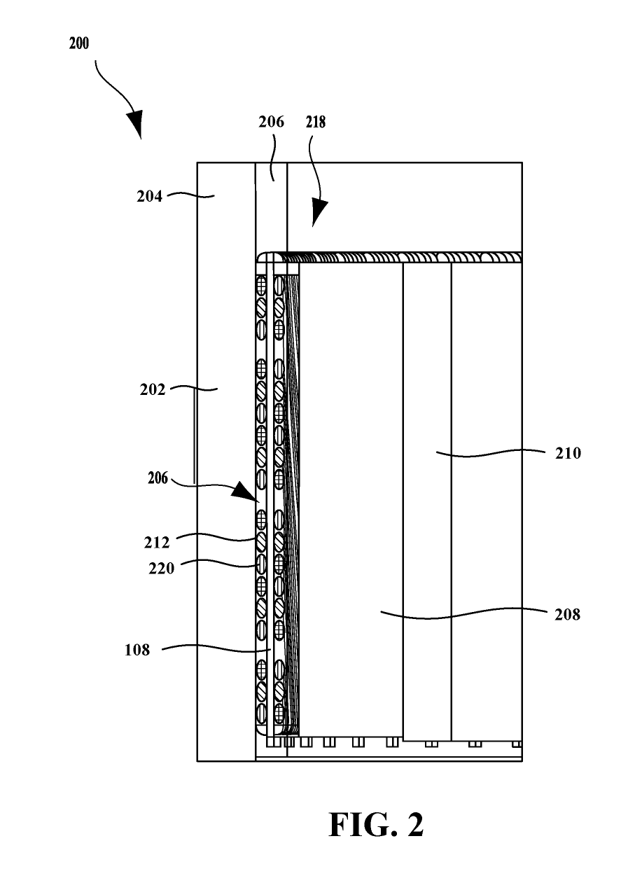

FIG. 2 is a diagram illustrating a laminated stack motor cross-section 200. In an aspect, the laminated stack motor cross-section 200 includes a wrapped bobbin such as a wire 220 wrapped bobbin (e.g., wire-wrapped cylindrical bobbin 108), inner and outer layer of a fiberglass strand 212, and interconnect PCB 204 are encapsulated in epoxy resin 206. The laminated stack 202 is bonded to the wrapped bobbin such as a wire 220 wrapped bobbin (e.g., wire-wrapped cylindrical bobbin 108), inner and outer layer of fiberglass strand 212, and interconnect PCB 204 with the epoxy resin 206. The laminated stack motor cross-section 200 includes a permanent magnet 208 and a cylindrical ferrous ring 210. In an aspect the wire-wrapped cylindrical bobbin 108 may consist of Garolite G-10. Garolite G-10 is a woven glass fabric laminated with an epoxy resin. The Garolite G-10 may be considered to be extremely high in mechanical strength, have low water absorption, and have good electrical characteristics, which are exhibited over a wide range of temperatures and humidities.

As illustrated in FIG. 2, in an aspect, a rotating electromechanical apparatus may include the stator 102. The stator winding 102 may include MULTIFILAR wire or litz wire. MULTIFILAR is a trademarked magnetic wire from MWS Wire Industries. Litz wire is a type of cable used in electronics to carry alternating current. The wire may be designed to reduce inefficiencies due to the skin effect and proximity effect in conductors used at frequencies up to about 1 MHz. Litz wire may include many thin wire strands, individually insulated and twisted or woven together, following prescribed patterns that may include several levels (e.g., groups of twisted wires twisted together). The result of these winding patterns may be to equalize the proportion of the overall length over which each strand is at the outside of the conductor and balance the induced turn-to-turn voltage, an effect not achieved with simple twisted-strand hookup wire.

The wire may be wrapped around the cylindrical bobbin 108 form. The stator 102 may include a wire-wrapped cylindrical bobbin 108. The stator 102 may include one or more fiberglass strands 212 wrapped around the wire-wrapped cylindrical bobbin 108. The stator 102 may include a laminated stack 202 on the wire 220, wire-wrapped cylindrical bobbin 108 and the one or more fiberglass strands 212. The stator 102 may include a cured potting material potting the wire-wrapped cylindrical bobbin 108, one or more fiberglass strands 212, and wire 220. The potting material may be epoxy resin.

In an aspect, the laminated stack 106 and the one or more fiberglass strands 212 may be on either the outer bobbin surface 112 or inner bobbin surface 110 of the wire-wrapped cylindrical bobbin 108 and the one or more fiber strands.

In an aspect, the wire-wrapped cylindrical bobbin 108 may be a wire-wrapped cylindrical bobbin 108 and the wire-wrapped cylindrical bobbin 108 may have an inner bobbin surface 110 and an outer bobbin surface 112. The wire-wrapped cylindrical bobbin 108 may have at least one wire wrapped around both the inner bobbin surface 110 and the outer bobbin surface 112.

In an aspect, the apparatus may be a motor configured to be driven by current supplied to the at least one wire.

In an aspect, the apparatus may be a generator configured to provide current from the at least one wire.

In an aspect, the at least one wire may be at least one of a wire bundle, a Litz wire bundle, an individual wire, or a wire tape.

In an aspect, the wire-wrapped cylindrical bobbin 108 may be porous. In an aspect, the potting material such as epoxy resin 206 infuses the wire-wrapped cylindrical bobbin 108, the at least one wire (e.g., of stator 102), the one or more fiberglass strands 212, and the voids between the fiberglass strands 212 and the stator having the laminated stack 106.

In an aspect, the one or more fiberglass strands 212 wrapped around the wire-wrapped cylindrical bobbin 108 may be wrapped around the inner bobbin surface 110 and outer bobbin surface 112 of the wire-wrapped cylindrical bobbin 108.

In an aspect, the stator 102 coil may have a rigidity reinforced by the one or more fiberglass strands 212 and the epoxy resin 206. The laminated stack 106 may be bonded to the wire-wrapped cylindrical bobbin 108 and the fiberglass strands 212 by the epoxy resin.

In an aspect, the stator having the laminated stack 106 may include a stack of thin cylindrical rings 218.

In an aspect, the one or more fiberglass strands 212 may include fiberglass.

In an aspect, the potting material may include at least one of epoxy resin 206.

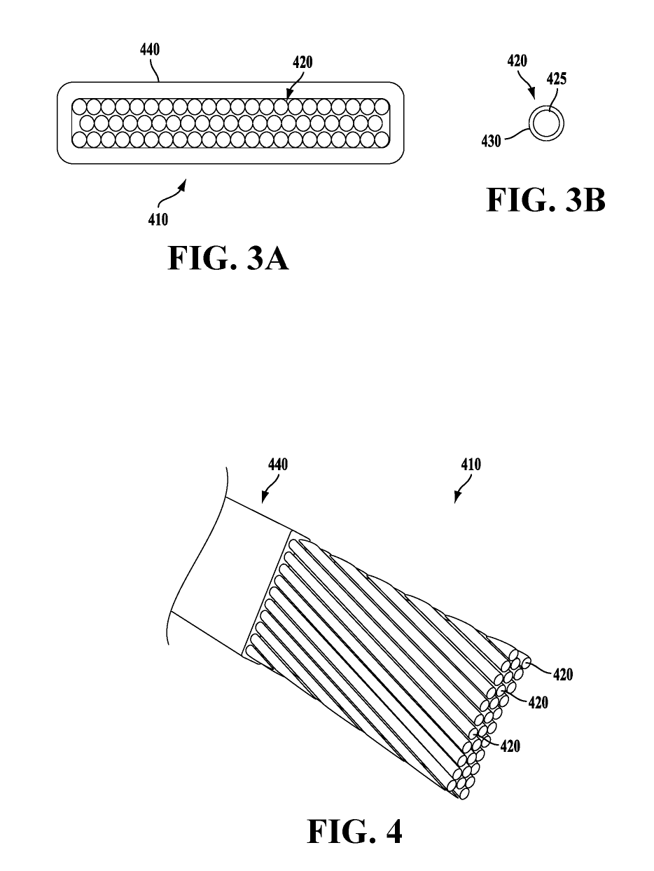

FIG. 3A illustrates a cross-section of a Litz wire bundle. FIG. 3B illustrates details of a cross-section of a Litz wire bundle. In an aspect, conductors may be a plurality of Litz wire bundles 410, preferably configured, for illustrative purposes as rectangular Litz wire bundles 410, as shown in FIGS. 3A and 3B. However, other wire or wire bundle arrangements may be used. Litz wires are advantageously used in motors and generators with coreless stators, due to the reduced eddy current losses in wire filaments of small diameter or cross-section. Additionally, they are more flexible and better adapted to arranging on a stator 102 than individual wires having the same conductor density as the Litz wire bundle 410. Referring to FIGS. 3A and 3B, individual wire filaments 420 include a conductor 425 have an insulation layer 430 surrounding each conductor 425. Rectangular shaped embodiments of individual wire filaments 420 have a higher packing fraction than round wire filaments, and thus have a greater conductor density. For illustration, round filaments are shown. The bundle may additionally have an insulating outer layer 440 surrounding the bundle.

As shown in FIG. 4, in a type-8 Litz wire bundle 410, the insulated individual wire filaments 420 may be twisted or braided, with an advantage that each filament is subject to the same average magnetic field of a permanent magnet rotor averaged over the bundle length and over time when subjected to relative rotation between the rotor and the stator.

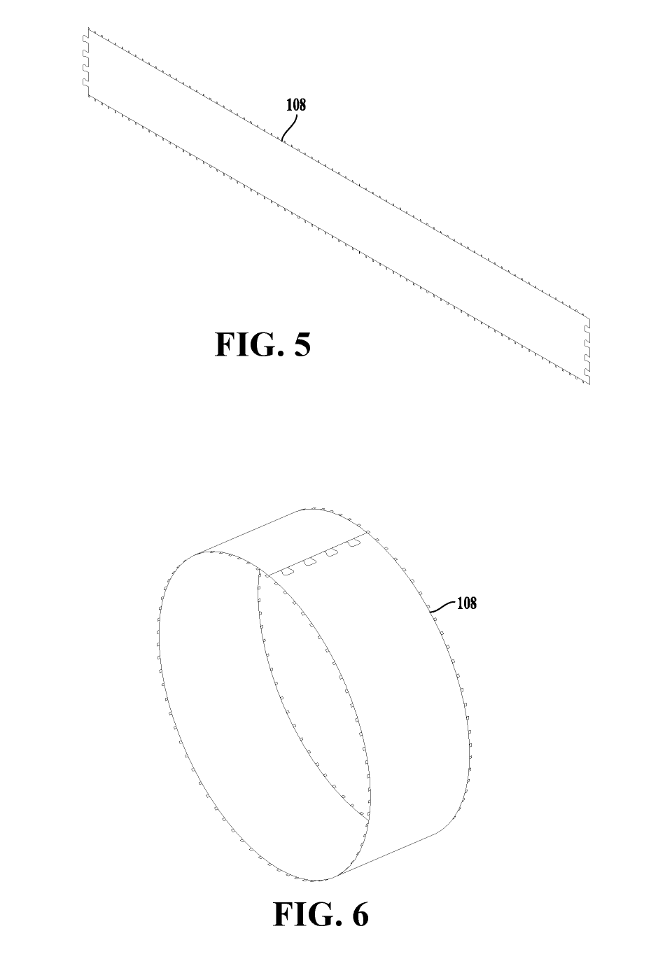

In an embodiment, FIG. 5 illustrates the shape of the flat form of the wire-wrapped cylindrical bobbin 108. Tabs at the end of the long dimension interleave when the wire-wrapped cylindrical bobbin 108 is curved to form a cylindrical structure. FIG. 6 illustrates the wire-wrapped cylindrical bobbin 108 curved to form a cylinder, and is shown without wires wound on the wire-wrapped cylindrical bobbin 108.

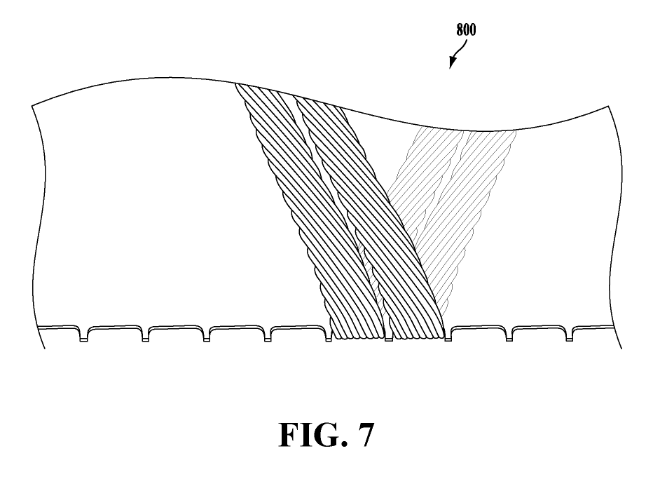

FIG. 7 is a drawing 800 of two Litz wire bundles wrapped around the edge of the bobbin. In an aspect, the guiding tabs may control the location and spacing of the bundles.

FIG. 8 is a diagram 900 illustrating a conceptual representation of a stator 902 and a rotor 904 of the present disclosure. The stator 902 is the stationary part of a rotary systems, e.g., such as the electric motor. The rotor 904 is a moving component of an electromagnetic system, e.g., such as the electric motor.

Eddie currents may cause losses to be (relatively) high in a solid stator, e.g., if the stator 902 includes solid ferrous material. In an aspect of the application, a stack of laminated ferrous material may be used to break up the induced current. By lowering the induced current, less heating may occur in the stator. Accordingly, in an aspect, the stator 902 may consist of multiple laminated layers.

In an aspect, the stator 902 may include a laminated stack 906. The laminated stack 906 may be on the inside or the outside of a wire-wrapped cylindrical bobbin 908. FIG. 1, above, illustrates an example with the laminated stack 106 outside of the wire-wrapped cylindrical bobbin 108. FIG. 8 illustrates an example with the laminated stack 906 inside of the wire-wrapped cylindrical bobbin 908. The wire-wrapped cylindrical bobbin 908 may include a cylindrical bobbin and at least one wire wrapped around both the inner and outer surfaces of the cylindrical bobbin. The wire-wrapped cylindrical bobbin 908 may have an inner bobbin surface 910 and an outer bobbin surface 912.

In an aspect, at least one wire may be wrapped around both the inner bobbin surface 910 and the outer bobbin surface 912 to form a winding. The wire-wrapped cylindrical bobbin further includes at least one fiber strand wrapped around the winding. A cured potting material may be used for potting the wire-wrapped cylindrical bobbin.

In an aspect, the laminated stack 906 may provide a low thermal resistance heat path 918.

In an aspect, the windings of the stator 902 may provide configurable windings that may accommodate a range of voltages.

In an aspect, the stator 902 may include an integrated rotor position sensor 920.

In an aspect, an assembly may be a cylindrical bobbin. The cylindrical bobbin may include a wire-wrapped cylindrical bobbin and the wire-wrapped cylindrical bobbin has an inner surface and an outer surface, and at least one wire wrapped around both the inner and outer surfaces of the cylindrical bobbin to form a wire-wrapped cylindrical bobbin having an inner surface and an outer surface. The wire-wrapped cylindrical bobbin may further include at least one fiber strand wrapped around the inner and outer surfaces of the wire-wrapped cylindrical bobbin. The assembly, e.g., the cylindrical bobbin including, e.g., including the inner surface and the outer surface, may further include a laminated ferrous stack on either of the inner or outer surface of the assembly.

In an aspect, a cylindrical bobbin may be porous and a potting material may infuse the cylindrical bobbin, the at least one wire, the one or more fiber strands, and the voids between the fiber strands and the stator ferrous ring.

In an aspect, the stator 902 has a rigidity reinforced by the one or more fiber strands and the laminated stack 906 is bonded to the cylindrical bobbin and the fiber strands.

In an aspect, the stator includes a stack of thin cylindrical rings.

In an aspect, the one or more fiber strands includes fiberglass.

In an aspect, the potting material includes at least one of epoxy and resin.

In an aspect, the rotor ferrous ring includes a solid cylindrical ring.

The rotor 904 includes a cylindrical ferrous ring 922. The cylindrical ferrous ring 922 may have an inner surface 924 and an outer surface 926. The cylindrical ferrous ring 922 may have a plurality of permanent magnets 928 arranged on either the inner surface 924 or the outer surface 126 of the cylindrical ferrous ring 122. The cylindrical ferrous ring 122 may have a plurality of permanent magnets 928 arranged on the inner surface 924 of the cylindrical ferrous ring 922 as illustrated in the example of FIG. 8.

In an aspect, the stator 902 and rotor 904 may have a large clear aperture.

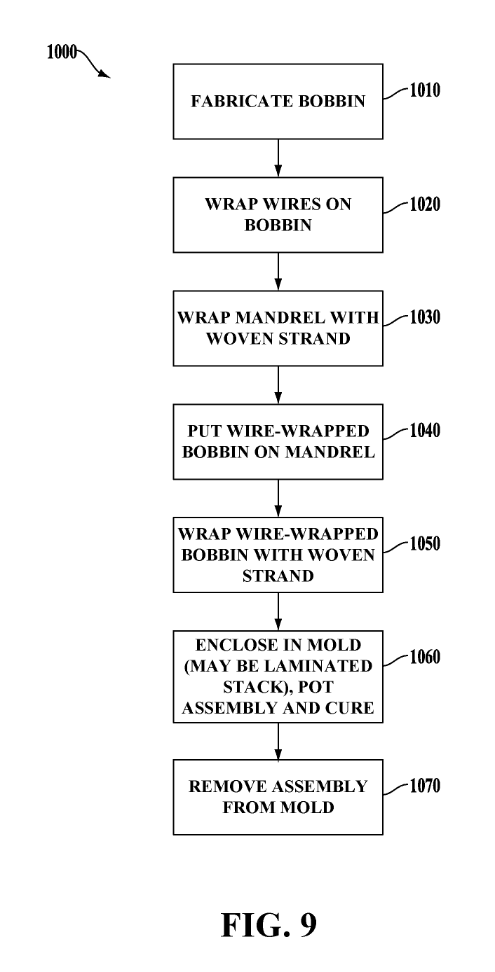

In an embodiment of the disclosure, a method 1000 of assembling a stator is described with reference to FIG. 9. The method 1000 of assembly begins at block 1010, in which the proper bobbin is fabricated as a flat form or in cylindrical form and arranged for wire wrapping. The bobbin may be machined, stamped or cut from suitable material. In block 1020 a plurality of wires (which may be Litz wires, as shown, or other wires or metal tape), corresponding to the number of multiples per phase and each phase, are wrapped around the bobbin, where the bobbin is arranged flat or in cylindrical form, and with the wires being guided by tabs located at a top and bottom edge of the bobbin. The bobbin and wire wrap configuration may be pressed together, with the wires wrapped with a minimum of slack. Preferably, the wires are machine wrapped on the bobbin for uniform tension, flatness and alignment. In block 1030 a fiber tape or woven cloth may be first wrapped around a cylindrical mandrel before placing the wire wrapped bobbin on the mandrel to form a wire wrapped cylinder. In block 1040 the wire wrapped bobbin is placed on a cylindrical mandrel, where the mandrel is selected to match the dimensions of the bobbin so that the angular phase relationship of the wires is continuously uniform around the circumference of the now cylindrically arranged bobbin.

In block 1050 the bobbin wire-coil combination is wrapped with a fiber strand or tape, which may be made, for example, of fiberglass. The tape provides compression of the bobbin-wire coil structure against the surface of the cylindrical mandrel and structural rigidity of the cylindrical wire-wrapped bobbin. In block 1060 the entire assembly may be enclosed in a mold, part of which may include a laminated stack. In an aspect, the mold, part of which may include a laminated stack, may enclose the assembly. Either the inner or outer surface of the mold may be a laminated stack. In another aspect, a mold and a laminated stack may be considered separate components. Accordingly, a combination of the mold and the laminated stack may encase the bobbin and mandrel, leaving an amount of gap on the inner and outer surfaces of the bobbin-wire-fiberglass structure for introduction of a curable liquid potting material, which may be an epoxy resin, which is then cured to form a self-supporting structure. After curing, the structure is removed from the mold (block 1070). Mold release compounds, well known in the art of epoxy fabrication, may be used to aid in release from the mold and mandrel.

The bobbin may be porous to permit the potting material to substantially infuse around and through the wire bundles, the wrapping tape and the bobbin, reinforcing the structural rigidity of the stator as a structure when cured. The construction of the stator may enhance the ability of the stator to withstand turn-to-turn voltage changes and forces generated when subject to electromagnetic induction.

The stator and rotor may then be assembled in additional steps to complete a generator or motor.

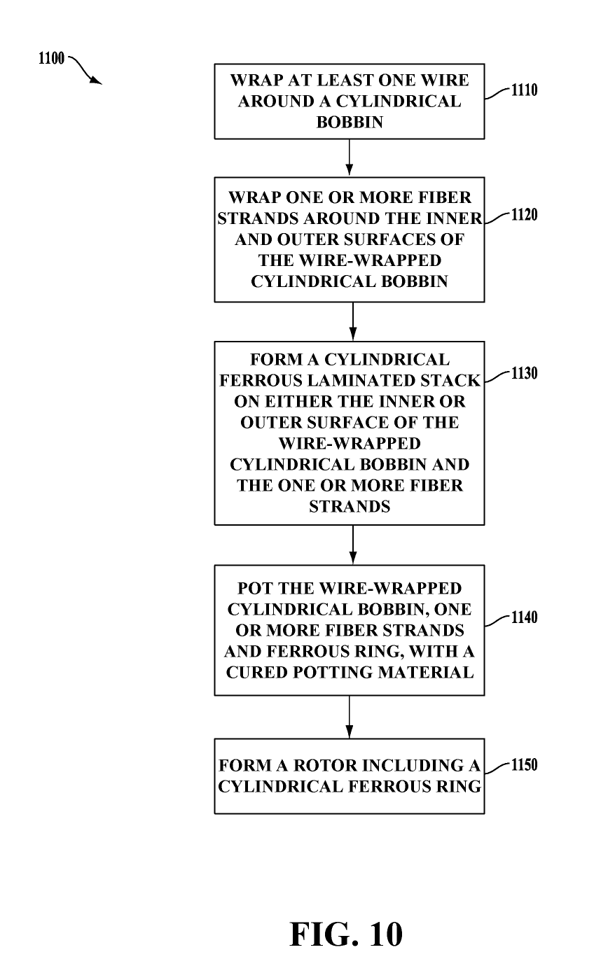

FIG. 10 is a flowchart 1100 of a method of laminated stack motor manufacture. The method may be used for forming a stator coil. The method may be performed in conjunction with forming an apparatus such as rotating electromechanical apparatus, e.g., a motor. For example, a stator 102 coil and a rotor 104 may both be formed. At 1110, the apparatus may be formed by wrapping at least one wire around a cylindrical bobbin having an inner surface and an outer surface, the at least one wire wrapped around both the inner surface and the outer surface of the cylindrical bobbin to form a wire-wrapped cylindrical bobbin having an inner surface and an outer surface. For example, the apparatus may be formed by wrapping at least one wire around a wire-wrapped cylindrical bobbin 108 having an inner bobbin surface 110 and an outer bobbin surface 112, the at least one wire wrapped around both the inner bobbin surface 110 and the outer bobbin surface 112 of the wire-wrapped cylindrical bobbin 108 to form a wire-wrapped cylindrical bobbin 108 having an inner bobbin surface 110 and an outer bobbin surface 112.

At 1120, the apparatus may be formed by wrapping one or more fiber strands around the inner and outer surfaces of the wire-wrapped cylindrical bobbin. For example, the apparatus may be formed by wrapping one or more fiberglass strands 212 around the inner surface and the outer surface of the wire-wrapped cylindrical bobbin 108.

At 1130, the apparatus may be formed by forming a laminated stack on either the inner or outer surface of the wire-wrapped cylindrical bobbin and the one or more fiber strands. For example, the apparatus may be formed by forming a laminated stack 202 on either the inner surface or the outer surface of the wire-wrapped cylindrical bobbin 108 and the one or more fiberglass strands 212.

At 1140, the apparatus may be formed by potting the wire-wrapped cylindrical bobbin, one or more fiber strands and ferrous ring, with a cured potting material, wherein the stator coil has a rigidity reinforced by the one or more fiber strands and potting material, and the laminated stack is bonded to the wire-wrapped cylindrical bobbin and the fiber strands. For example, the apparatus may be formed by potting (e.g., epoxy resin) the wire-wrapped cylindrical bobbin 108, one or more fiberglass strands 212 and ferrous ring 202 with a cured potting material (e.g., epoxy resin). The stator 102 coil may have a rigidity reinforced by the one or more fiberglass strands 212 and the epoxy resin 206, and the laminated stack 202, and is bonded to the wire-wrapped cylindrical bobbin 108 and the fiberglass strands 212.

At 1150, the apparatus may be formed by forming a rotor including a cylindrical ferrous ring having an inner and an outer surface, and a plurality of permanent magnets arranged on either the inner or outer surface of the cylindrical ferrous ring. In an example, the apparatus may be formed by forming a rotor 104 including a cylindrical ferrous ring 122, having an inner surface 124, an outer surface 126, and a plurality of permanent magnets 128 arranged on either the inner surface 124 or the outer surface 126 of the cylindrical ferrous ring 122.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

1. An apparatus comprising:
a stator coil comprising a laminated stack including:
a wire-wrapped cylindrical bobbin, including:
a cylindrical bobbin having an inner bobbin surface and an outer bobbin surface,
at least one wire wrapped around both the inner and outer surfaces of the cylindrical bobbin to form a winding, and
a first layer of one or more fiber strands wound on the inner surface of the wire-wrapped cylindrical bobbin and a second layer of one or more fiber strands wound on the outer surface of the wire-wrapped cylindrical bobbin; and
a cured potting material potting the wire-wrapped cylindrical bobbin and bonding the wire-wrapped cylindrical bobbin together; and
a rotor including a cylindrical ferrous ring having an inner and an outer surface, and a plurality of permanent magnets arranged on either the inner or outer surface of the cylindrical ferrous ring.

2. The apparatus of claim 1, wherein the laminated stack and the one or more fiber strands is on either the inner or outer surface of the cylindrical bobbin and the one or more fiber strands.

3. The apparatus of claim 1, wherein the cylindrical bobbin comprises the wire-wrapped cylindrical bobbin and the wire-wrapped cylindrical bobbin has an inner surface and an outer surface, and at least one wire wrapped around both the inner and outer surfaces of the cylindrical bobbin to form the wire-wrapped cylindrical bobbin having an inner surface and an outer surface.

4. The apparatus of claim 3, wherein the apparatus is a motor configured to be driven by current supplied to the at least one wire.

5. The apparatus of claim 3, wherein the apparatus is a generator configured to provide current from the at least one wire.

6. The apparatus of claim 3, wherein the at least one wire comprises at least one of a wire bundle, a Litz wire bundle, an individual wire, or a wire tape.

7. The apparatus of claim 3, wherein the cylindrical bobbin is porous and the cured potting material infuses the cylindrical bobbin, the at least one wire, the one or more fiber strands, and voids between the fiber strands and the laminated stack.

8. The apparatus of claim 3, wherein the one or more fiber strands wrapped around the cylindrical bobbin are wrapped around the inner and outer surfaces of the wire-wrapped cylindrical bobbin.

9. The apparatus of claim 1, wherein the stator coil has a rigidity reinforced by the one or more fiber strands and the laminated stack is bonded to the cylindrical bobbin and the fiber strands.

10. The apparatus of claim 1, wherein the laminated stack comprises a stack of thin cylindrical rings.

11. The apparatus of claim 1, wherein the one or more fiber strands includes fiberglass.

12. The apparatus of claim 1, wherein the cured potting material comprises at least one of epoxy and resin.

13. The apparatus of claim 1, wherein the cylindrical ferrous ring comprises a solid cylindrical ring.

14. A method of forming an apparatus, comprising:
wrapping at least one wire around a cylindrical bobbin having an inner surface and an outer surface, the at least one wire wrapped around both the inner and outer surfaces of the cylindrical bobbin to form a wire-wrapped cylindrical bobbin having an inner surface and an outer surface;
wrapping one or more fiber strands around the inner and outer surfaces of the wire-wrapped cylindrical bobbin;
forming a laminated stack on either the inner or outer surface of the wire-wrapped cylindrical bobbin and the one or more fiber strands;
potting the wire-wrapped cylindrical bobbin, one or more fiber strands and ferrous ring, with a cured potting material; and
forming a rotor including a cylindrical ferrous ring having an inner and an outer surface, and a plurality of permanent magnets arranged on either the inner or outer surface of the cylindrical ferrous ring.

15. The method of claim 14, further comprising:
fabricating the cylindrical bobbin before wrapping the at least one wire around the cylindrical bobbin;
wrapping a mandrel with at least one woven strand;
putting the wire wrapped bobbin on the mandrel;
wrapping the wire-wrapped bobbin with at least one woven strand;
enclosing the cylindrical bobbin, the one or more fiber strands around the inner and outer surfaces of the wire-wrapped cylindrical bobbin in a mold, with the laminated stack forming an assembly;
potting the assembly;
curing the assembly;
and removing the assembly from the mandrel.

16. The method of claim 15, wherein the mold comprises the laminated stack.

17. The method of claim 15, wherein the apparatus comprises a motor configured to be driven by current supplied to the at least one wire.

18. The method of claim 15, wherein the apparatus comprises a generator configured to provide current from the at least one wire.

19. The method of claim 18, wherein the at least one wire comprises at least one of a wire bundle, a Litz wire bundle, an individual wire, or a wire tape.

20. The method of claim 18, wherein the cylindrical bobbin is porous and the cured potting material infuses the cylindrical bobbin, the at least one wire, the one or more fiber strands, and voids between the fiber strands and the laminated stack.
